(19) United States
(12) Patent Application Publication
(10) Pub. No.: US 2020/0090290 A1
(43) Pub. Date: Mar. 19, 2020

(54) METHOD AND OBJECT-CENTRIC SERVICE DELIVERY SYSTEM

(71) Applicant: ALFRED CHEUNG, SAN FRANCISCO, CA (US)

(72) Inventor: ALFRED CHEUNG, SAN FRANCISCO, CA (US)

(73) Assignee: ALFRED CHEUNG, SAN FRANCISCO, CA (US)

(21) Appl. No.: 16/132,468

(22) Filed: Sep. 17, 2018

(51) Int. Cl. G06Q 50/22; G06Q 10/06

(52) U.S. Cl. CPC G06Q 50/22; G06Q 10/06312

(57) ABSTRACT

A method and an Object-centric Service Delivery System (OSDS) (102) is disclosed. The OSDS (102) receives individualized information of an object (120) and processes the individualized information of the object (120) to determine a current status of the object (120). Thereafter, the OSDS (102) analyzes the individualized information of the object (120) and individualized information of other objects that are contextually related to the object (120) to predict a future state of the object (120). The OSDS (102) also determines a desired state of the object (120) and recommends one or more service actions that facilitate the object (120) in attaining the desired state.

### BACKGROUND

Today government organizations, non-profit agencies and charities need to maximize the reach and efficiency of their resources. However, many such entities, including cities, counties, non-profits and charities still depend on MS-Excel® spreadsheets, emails, and one-dimensional software solutions to manage and track the numerous social welfare programs. Managing and tracking complex programs through MS-Excel and emails is extremely time consuming and prone to errors. One-dimensional software solutions, such as document management solution, finance/accounting solution, content management system (CMS), project management software etc. solve only part of the problem. Preparation, tracking, managing, forecasting, predicting, reporting, analysis and compliance obligations for social welfare programs require an integrated approach.

It is with respect to these and other general considerations that aspects disclosed herein have been made. Also, although relatively specific problems may be discussed, it should be understood that the aspects should not be limited to solving the specific problems identified in the background or elsewhere in this disclosure.

### SUMMARY

In summary, the disclosure generally relates to method and object-centric service delivery system (OSDS). More specifically, the OSDS and methods disclosed herein enable a user, for example an employee or an agent of a government entity, a charity or a non-profit organization to determine what services, for example, financial aid, training etc. should be provided to an object, such as an individual or a family so that the object achieves a desired state. The desired state could be, for example, a state where the object is financially independent or self-sufficient and thus no longer requires any financial or other assistance from the government entity, the charity or the non-profit organization.

One aspect of the disclosure is directed to an object-centric service delivery system (OSDS). The OSDS includes at least one processor and memory. The memory encodes computer executable instructions that, when executed by the at least one processor is operative to:

receive an individualized information of an object, wherein the object is from a plurality of objects, the individualized information comprising one or more performance parameters, a performance parameter covers a performance area of the object, and wherein the performance parameter has a set of performance values;

process the individualized information of the object to determine a current state of the object;

analyze the individualized information of the object and individualized information of other objects that are contextually related to the object, wherein the other objects are from the plurality of objects;

predict a future state of the object;

determine a desired state of the object; and

recommend one or more service actions, wherein the one or more service actions facilitate the object attaining the desired state.

Another aspect of the disclosure is directed to a method for object-centric service delivery. The method includes:

receiving an individualized information of an object, wherein the object is from a plurality of objects, the individualized information comprising one or more performance parameters, wherein a performance parameter covers a performance area of the object, and wherein the performance parameter has a set of performance values;

processing the individualized information of the object to determine a current state of the object;

analyzing the individualized information of the object and individualized information of other objects that are contextually related to the object, wherein the other objects are from the plurality of objects;

predicting a future state of the object;

determining a desired state of the object; and

recommending one or more service actions, wherein the one or more service actions facilitate the object attaining the desired state.

One aspect of the disclosure is directed to a computer program product. The computer program product comprising a computer readable storage medium having program instructions embodied therewith, wherein the computer readable storage medium is not a transitory signal per se, the program instructions readable by at least one processing circuit to cause the at least one processing circuit to perform a method of object-centric service delivery, the method comprising:

receiving an individualized information of an object, wherein the object is from a plurality of objects, the individualized information comprising one or more performance parameters, wherein a performance parameter covers a performance area of the object, and wherein the performance parameter has a set of performance values;

processing the individualized information of the object to determine a current state of the object;

analyzing the individualized information of the object and individualized information of other objects that are contextually related to the object, wherein the other objects are from the plurality of objects;

predicting a future state of the object;

determining a desired state of the object; and

recommending one or more service actions, wherein the one or more service actions facilitate the object in attaining the desired state.

One aspect of the disclosure is directed to an object-centric service delivery system (OSDS). The OSDS includes at least one processor and memory. The memory encodes computer executable instructions that, when executed by the at least one processor is operative to:

receive an individualized information of an object, wherein the object is from a plurality of objects, the individualized information comprising one or more performance parameters, wherein a performance parameter covers a performance area of the object, and wherein the performance parameter has a set of performance values;

wherein the object has one or more associated sub-objects, wherein a sub-object has an individualized information associated with the sub-object, and wherein the object and the one or more associated sub-objects constitute an object family;

process the individualized information of the object family to determine a current state of the object family;

analyze the individualized information of the object family and individualized information of other objects that are contextually related to the object and individualized information of other objects families that are contextually related to the object family, wherein the other objects are from the plurality of objects, and wherein the other object families are from a plurality of object families;

predict a future state of the object family;

determine a desired state of the object family; and

recommend one or more service actions, wherein the one or more service actions facilitate the object family in attaining the desired state.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

The accompanying figures, where like reference numerals refer to identical or functionally similar elements throughout the separate views, and which, together with the detailed description below, are incorporated in and form part of the specification, serve to further illustrate various embodiments and explain various principles and advantages, all in accordance with the present invention.

FIG. 1 is an example block diagram that illustrates an environment 100 in accordance with various embodiments of the present invention;

FIG. 2 is a block diagram that illustrates an environment 200 in accordance with various embodiments of the present invention;

FIG. 3 is a flowchart illustrating a method 300 for object-centric service delivery in accordance with various embodiments of the present invention;

FIG. 4 is a flowchart illustrating an exemplary method 400 for setup of object-centric service delivery in accordance with various embodiments of the present invention;

FIG. 5 is a flowchart illustrating an exemplary method 500 for determining contextually related objects in accordance with various embodiments of the present invention;

FIG. 6 is a flowchart illustrating an exemplary method 600 to identify objects that need at least one service action, in according to various embodiments of the present invention;

FIG. 7A and 7B illustrate a prediction methodology in accordance with an embodiment of the present invention;

FIG. 8 is a flowchart illustrating an exemplary method 800 for object centric service delivery in accordance with another embodiment of the present invention;

FIG. 9 is a flow diagram illustrating an exemplary method 900 for recommending one or more service actions in accordance with various embodiments of the present invention;

FIG. 10 is a block diagram illustrating physical components (e.g., hardware) of a computing device 1000 with which aspects of the disclosure may be practiced.

Skilled artisans will appreciate that elements in the figures are illustrated for simplicity and clarity and have not necessarily been drawn to scale. For example, the dimensions of some of the elements in the figures may be exaggerated, relative to other elements, to help in improving an understanding of the embodiments of the present invention.

### DETAILED DESCRIPTION

In the following detailed description, references are made to the accompanying drawings that form a part hereof, and in which are shown by way of illustrations specific aspects or examples. These aspects may be combined, other aspects may be utilized, and structural changes may be made without departing from the spirit or scope of the present disclosure. The following detailed description is therefore not to be taken in a limiting sense, and the scope of the present disclosure is defined by the claims and their equivalents.

In this document, the terms “comprises,” “comprising,” or any other variation thereof, are intended to cover a non-exclusive inclusion, such that a process, method, article or apparatus that comprises a list of elements does not include only those elements but may include other elements that are not expressly listed or inherent in such a process, method, article or apparatus. An element proceeded by “comprises . . . a” does not, without more constraints, preclude the existence of additional identical elements in the process, method, article or apparatus that comprises the element.

The term “another,” as used in this document, is defined as at least a second or more. The terms “includes” and/or “having,” as used herein, are defined as comprising. The term “program,” as used herein, is defined as a sequence of instructions designed for execution on a specialized computer system. A “program,” or “computer program,” may include a subroutine, a function, a procedure, an object method, an object implementation, an executable application, an applet, a servlet, a source code, an object code, a shared library/dynamic load library and/or other sequence of instructions designed for execution on a specialized computer system.

Certain portions of this application, such as the Abstract and Summary, are provided to allow the reader to quickly ascertain the nature of the disclosure. They are submitted with the understanding that they will not be used to interpret or limit the scope or meaning of the claim.

Social welfare ecosystem includes three kinds of players. The funders, the implementers and the recipients. The funders are entities or individuals that fund social welfare schemes. Funders include government entities, private foundations, businesses, charities and philanthropic individuals. Funders, in aggregate, typically spend Billions of dollars every year on social welfare schemes and/or programs to help individuals, families and small businesses in need.

The implementers typically include entities, for example, non-profit organizations and government agencies which carry out social welfare schemes or programs at the grass root level. In most cases the implementers compete with one another for funds offered by the funders. In some cases, the funders also implement the social welfare schemes directly and without the help of implementers. Finally, the recipients or objects include individuals, families and small businesses in need, who receive benefits of these social welfare schemes or programs.

The players in this social welfare ecosystem, for example, funders and implementers need to maximize the efficiency of their resources so that they can reach out to more and more potential recipients in need. However, even now, many of these players, such as cities, counties, charities, and non-profits depend upon MS-Excel® spreadsheets, emails and one-dimensional software solutions to manage their social welfare schemes and programs.

Management through spreadsheets and emails is time consuming and prone to errors. The one-dimensional software solutions, for example Enterprise Resource Planning (ERP), Supply Chain Management (SCM) implemented by one player is often incompatible and disconnected with IT systems and databases used by other players in the social welfare ecosystem. This leads to overheads and inefficiencies. In effect, Billions of dollars, meant to help recipients, are being managed by inefficient, fractured and segregated systems. As such, there is currently no system that provides an ingenerated solution to address these issues. This lack of integration also results in mismatch between demand and supply. For example, due to the lack of integration, the welfare schemes or programs are planned without a comprehensive information about the needs of the recipients. This further amplifies the inefficiencies of the social welfare ecosystem.

The method and object-centric service delivery system (OSDS) disclosed herein provides an integrated solution for unified funding, program and operations management platform for the various players in the social welfare ecosystem. In an embodiment, OSDS architecture is centered around an object, such as an individual, family or a small business entity. Typically, the object is a recipient of a social welfare scheme or program. In this embodiment, the OSDS architecture treats the object as the central hub that drives the demands of services which are fulfilled by the funders and implementers. This architecture enables a user, for example, an employee or an agent of the funder or the implementer to efficiently identify and manage service actions for the object. The service actions facilitate the object attaining a desired state. In another embodiment, the OSDS provides a self-service model wherein the object, for example an individual can access and register for one or more service actions. Typically, the object can register for a service action that he/she may qualify for. In an embodiment, the one or more service actions are managed in a real time by the OSDS.

In an embodiment, the OSDS architecture has the object as the central hub. In an embodiment, the OSDS is implemented over a cloud and this integrates implementers, funders and recipients. The OSDS ensures real time update and collaboration between the players of the social ecosystem. This is different from the one-dimensional solutions, such as, the ERP systems that are centered around a player. This architecture of the OSDS streamlines the reporting, compliance and tracking of the programs and schemes. Also, each player can also better predict and plan as they now have access to real time information about objects or recipients and other players.

Progress in Artificial intelligence (AI) and its utilization in fields like medical, diagnostic, cybersecurity, robotics is changing the world around us. There are many approaches that fall under the broad umbrella of AI. Some examples include neural networks, rule-based systems, machine learning, deep learning and genetic algorithms. Typically, rule-based systems utilize automatic rule inference, such as rule-based machine learning to develop rules. An example of a rule-based system is the domain specific expert system, such as a medical diagnostic system that uses rules to make deductions or choices. These rule-bases systems are generally suited for structured domains where there are general and well accepted methodologies. Neural networks and genetic algorithms on the other hand use a different approach. They need to be trained on a data set from which they derive patterns. Genetic algorithms are generally better suited for unstructured domains. Genetic algorithm-based AI systems guide the user by enhancing their judgment, rather than replacing them.

In an embodiment, the OSDS not only provides an integrated solution for managing social service programs but also the necessary intelligence that facilitates object level programming of services and outcomes. In an embodiment, the OSDS incorporates AI techniques such as machine learning to facilitate an object or an agent of an implementer, such as, an employee of a government body or a charity to manage services rendered to the object in real-time. Typically, the OSDS automatically defines or identifies predictive rules or patterns from individualized information associated with the plurality of objects. Typically, the OSDS is capable of presenting the results in an easy to understand format. In an embodiment, the OSDS simulates a plurality of service actions and presents the effects of implementing each service action in a Graphical User Interface (GUI). This provides a guide to agents of the funders and implementers. Thus, the OSDS can be used to manage a variety of social welfare programs and/or philanthropic impact activities.

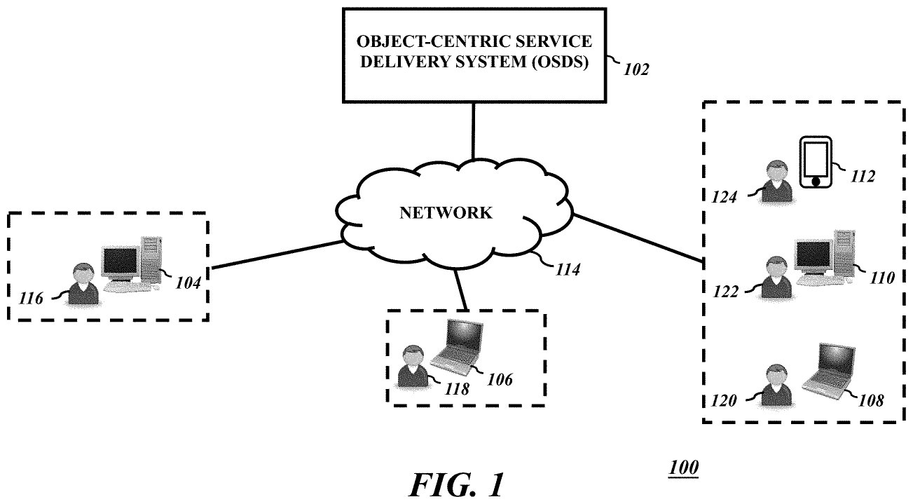

FIG.1 is a block diagram that illustrates environment 100 where various embodiments of the present invention may be practiced. The environment 100 includes an object-centric service delivery system (OSDS) 102, a plurality of client devices, for example, a client device 104, a client device 106, a client device 108, a client device 110, and a client device 112. Each client device of the plurality of client devices is connected to the OSDS 102 via a network 114.

The OSDS 102 may be implemented as a distributed system, for example one or more elements of the OSDS 102 may be located across a wide-area network from other elements of the OSDS 102. In another embodiment, the OSDS 102 may be implemented as a standalone server. In yet another embodiment, the OSDS 102 may be implemented over a cloud as a Software as a Service (SaaS). Examples of a client device, for example the client device 104 include, but are not limited to, a handheld computer, a personal digital assistant (PDA), a tablet computer, a laptop computer, a desktop computer, a cellular telephone, a smart phone, an enhanced general packet radio service (EGPRS) mobile phone, a media player, a navigation device, a game console, a television, a remote control, or a combination of any two or more of these data processing devices or other data processing devices.

The network 114 may include local-area networks (LAN), wide-area networks (WAN), wireless networks (e.g., 802.11 or cellular network), the Public Switched Telephone Network (PSTN) network, ad-hoc networks, personal area networks (e.g., Bluetooth) or other combinations or permutations of network protocols and network types. The network 114 may include a single local area network (LAN) or wide-area network (WAN), or combinations of LAN's or WAN's, such as the Internet. In an embodiment, the various client devices, for example, the client device 104, 106 and 108 are coupled to the network 114 via one or more wired or wireless connections.

The environment 100 further includes one or more agents of the funder, for example, a funder agent 116; one or more agents of the implementer, for example an implementer agent 118 and a plurality of objects, for example an object 120, an object 122 and an object 124. In an embodiment, the funder agent 116 accesses the OSDS 102 by using the client device 104; the implementer agent 118 accesses the OSDS by using the client device 106; and an object, for example the object 120 accesses the OSDS 102 by using the client device 108. Typically, the funder agent 116 is an individual, such as an employee, contractor or an authorized representative of a funder such as a government entity/agency, private foundation, business, or charity. In any case, the funder agent 116 is an authorized representative of the funder who wishes to utilize the OSDS 102. Typically, the implementer agent 118 is an individual, such as an employee, contractor or an authorized representative of an implementer such as a non-profit, or Non-Government Organization (NGO) etc. In any case, the implementer agent 118 is an authorized representative of the implementer who wishes to utilize the OSDS 102.

In an embodiment, the implementer agent 118 is an individual, such as an employee or an authorized representative of an implementer. An object, for example, the object 120, is an individual, member of family or an entity, for example, business that is recipient of benefits of a social welfare scheme or program.

The OSDS 102 provides an integrated solution for unified funding, program and operation management platform for the players in the public welfare ecosystem. In an embodiment, OSDS 102 provides a solution that is centered around the plurality of objects. In this embodiment, the OSDS architecture treats each object, for example the object 120 as the central hub that drives the demands of services which are fulfilled by the funders and implementers. This solution enables a user, for example, the funder agent 116, the implementer agent 118, or the object 120 to efficiently plan for and manage services rendered to an object, for example, the object 120. Managing services include, but is not limited to, setting up object-centric service delivery, determining contextually related objects, identifying objects that need at least one service action, implementing prediction methodology to determine current state and future state of the object, determining a desired state of the object, creating and selecting one or more service actions, adding one or more service actions, removing one or more service actions, monitoring performance of the object etc. Typically, the OSDS 102 manages services in real time. In an embodiment, the OSDS 102 provides functionalities and supports users such as the funder agent 116, the implementer agent 118, and the object 120 to manage services. In another embodiment, the OSDS 102 is powered by AI and has the ability to manage services and has the capability to partially replace the implementer agent 118.

In an embodiment, the OSDS 102 provides necessary intelligence that facilitates object level programming of services and outcomes. Typically, the OSDS 102 incorporates AI techniques such as machine learning to facilitate the implementer agent 118 to manage services rendered to an object, for example the object 120 in real-time. Typically, the OSDS 102 automatically determines predictive rules or patterns from individualized information associated with the plurality of objects. In an embodiment, the OSDS 102 is capable of presenting the results in an easy to understand format. Typically, the results are presented on a graphical user interface (GUI). In an embodiment, the OSDS 102 enables simulation of scenarios that can help in visualizing and understanding effects of the one or more service actions. Thus, the OSDS 102 can be used to manage a variety of social service programs and/or philanthropic impact activities.

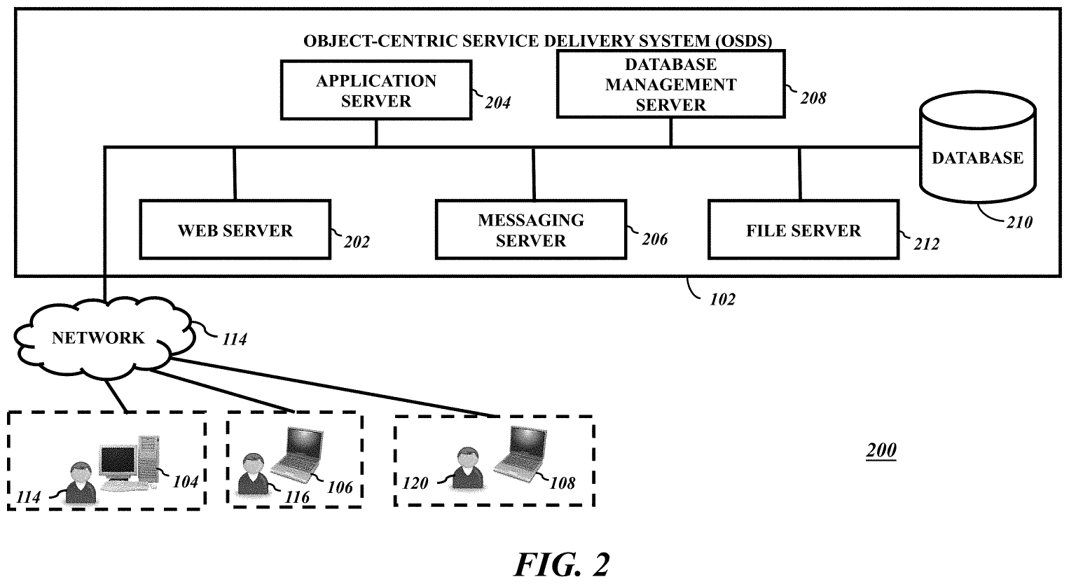

FIG. 2 is a block diagram that illustrates an environment 200 where various embodiments of the present invention may be practiced. The environment 200 includes the OSDS 102, a plurality of client devices, for example, the client device 104, the client device 106 and the client device 108. Each client device of the plurality of client devices are connected to the OSDS 102 via the network 114. In an embodiment, the OSDS 102 includes a web server 202, an application server 204, a messaging server 206, a database management server 208, which is used to manage at least a database 210, and a file server 212.

The web server 202 may communicate with the file server 212 to publish or serve files stored on the file server 212. The web server 202 may also communicate or interface with the application server 204 to enable web-based presentation of information. For example, the application server 204 may consist of scripts, applications, or library files that provide primary or auxiliary functionality to the web server 202 (e.g., multimedia, file transfer, or dynamic interface functions). In addition, the application server 204 may also provide some or the entire interface for the web server 202 to communicate with one or more of the other servers in the OSDS 102, e.g., the messaging server 206 or the database management server 208.

The application server 204 may also provide a platform to create, manage, and administer the plurality of objects. The database 210 may include data to manage the plurality of objects, individualized information associated with the object, data about a plurality of funders, implementers and social welfare programs and schemes. The database 201 may be implemented as a relational database, a centralized database, a distributed database, an object-oriented database, a cloud-based database or a flat database in various embodiments.

In an embodiment, a user, for example the funder agent 116, the implementer agent 118, or the object 120 may interface with the OSDS 102, such as by using the web server 202, to initiate an activity. The activity may include approving a service action for an object, predicting a future state of the object etc. The activity may also include other types of activities, such as processing, account activation, account access, routine security checks, or surveys etc. The user, for example, the implementation agent 114 may be presented one or more user-interface elements, such as drop-down lists, check boxes, radio buttons, text input fields, or the like. The user-interface may be implemented using a variety of programming languages or programming methods, such as HTML, VBScript, JavaScript, XML, XSLT, AJAX, Java, and Swing. In various embodiments, the OSDS 102 may provide a variety of interfaces and applications for the agents and/or the objects, which may be defined using the application server 204. In an embodiment, the user-interface can be accessed from a mobile device, such as a mobile phone, smartwatch etc. by using a mobile app.

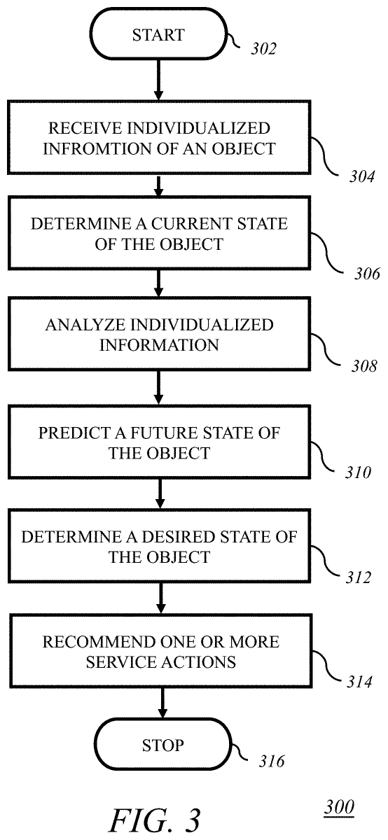

FIG. 3 is a flowchart illustrating an exemplary method 300 for object-centric service delivery according to various embodiments of the present invention. The exemplary method 300 is merely an illustration of the setup of the object-centric service delivery. Other methods and processes are possible, and more or fewer steps of setup may be implemented by the OSDS 102 in various embodiments. To describe the method 300, reference has been made to FIG. 1 and FIG. 2, although it should be understood that the method 300 could be implemented in any other suitable environment or network. Moreover, the invention is not limited to the order in which the steps are listed in the method 300. In an embodiment, the method 300 is performed by the OSDS 102.

At step 302, the method for object-centric service delivery is initiated. At step 304, OSDS 102 receives an individualized information of an object, for example, for the object 120. In an embodiment, the individualized information includes one or more performance parameters. The performance parameter covers a performance area of the object, for example performance areas of the object 120. In an embodiment, the individualized information of the object is stored in the database 210. Typically, the database 210 stores the individualized information of the plurality of objects, for example, the object 120, the object 122 and the object 120. In an embodiment, the object is an individual or a family. In another embodiment, the object is an entity, for example a small business. In any case, the object is an entity or an individual that can be a recipient of a service action such as a social welfare scheme or program.

In an embodiment, each object of the plurality of objects provide their individualized information to the OSDS 102 while an object account is created with the OSDS 102. Typically, the OSDS 102 enables a sign-up process having a plurality of questions for collecting the individualized information. The object, for example, the object 120 provides the individualized information while creating his object account. Alternately, the object can provide the information to the implementer agent 118 or to the funder agent 116 who can create the object account and provide the individualized information of the object to OSDS 102. In an embodiment, the OSDS 102 provides an intelligent agent that can collect the individualized information of the object 120. Typically, the intelligent agent is powered by AI and engages with the object 120 in a conversational or Q&A format to collect the individualized information of the object 120. In an embodiment, the intelligent agent utilizes AI and/or voice inputs to gather the individualized information of the object 120.

In an embodiment, the performance parameter is at least one of from the group comprising an intrinsic parameter, and an extrinsic parameter. Examples of the performance parameters include, but are not limited to citizenship, correctional, education and skills, employment, entrepreneurial, annual income, health, housing, identification, personal finance, veteran benefit, and size of household, residence address. Typically, the intrinsic parameters are parameters that are specific to the object, for example ethnicity, income. Typically, the extrinsic parameters are parameters that are external to the object, for example, unemployment rate, labor participation rate, consumer price index, per capita income of the locality, unemployment insurance claims data etc.

In an embodiment, the performance parameter has a set of performance values. Typically, each performance value of the set of performance values is associated with a time-stamp. For example, annual income is a performance parameter that has a set of three performance values: $30,000, $25,700 and $42,000 and three timestamps of Dec. 31, 2015, Dec. 31, 2016 and Dec. 31, 2017 respectively. Similarly, household size is another performance parameter that has the value of 3, 4 and 5 and three timestamp values of 2014, 2015 and 2016. In an embodiment, each of the one or more performance parameter has a normalized value, for example, a numerical value on a scale of 1 to 10 or a percentage value from 0% to 100%.

At step 306, the OSDS 102 processes the individualized information of the object, for example, the object 120 to determine a current state of the object. In an embodiment, the current state of the object is based on the weighted average of one or more performance values. Typically, the one or more performance values are the performance value that correspond to the most recent timestamp.

Typically, the current state of the object has a numerical value, for example a value between 1 and 100. In an embodiment, the current state of the object has a non-numerical value, for example a color value, such as green, yellow, orange or red etc. In an embodiment, the current state of the object is used by the implementer, for example an employee of a non-profit, to determine if the object needs support of any social welfare scheme or program.

In an embodiment, the current state of the object, for example, the object 120 is determined by applying AI techniques. In another embodiment, the current state of the object is determined by applying at least one of from the group including a trend analysis, an induction analysis, a time series analysis, a correlation analysis, a regression analysis, a frequency distribution analysis, a diagnostic modeling, a predictive modeling, a prescriptive modeling, a descriptive modeling, data mining, text analytics, forecasting, and simulation.

In an embodiment, the OSDS 102 applies at least one of a classification and regression analysis to the plurality of objects to identify a subset of performance parameters that contribute most to the current state of the object. In this embodiment, the OSDS 102 analyses a test data set. The test data set includes individualized information of a first set of objects along with the current state of each object of the first set of objects. In an embodiment, the OSDS 102 applies at least one of classification and regression analysis and/or induction analysis to the test data set to determine the parameters that most contribute to the current state of the object. In another embodiment, the OSDS 102 applies the classification and regression analysis and/or induction analysis to the test data set to determine the weightage value to be associated with each performance parameter.

In an embodiment, the OSDS 102 determines that the current state of the object is below a predefined minimum. Typically, the predefined minimum helps in taking preventive steps to help the object proactively. The preventive steps, are designed to prevent the object from attaining a state where it is likely to rely on service actions. In an embodiment, when the current state of the object is below a predefined minimum then the object is more likely than not to be in need of service actions in the near future. This information can be useful for the funders and the implementers as the cost of taking preventive actions is typically less than the cost of taking remedial actions at a later stage.

At step 308, the OSDS 102 analyzes the individualized information of the object and individualized information of other objects that are contextually related to the object. The other objects are from the plurality of objects. In an embodiment, the analyzing includes at least one of from the group including a trend analysis, an induction analysis, a time series analysis, a correlation analysis, a regression analysis, a frequency distribution analysis, a diagnostic modeling, a predictive modeling, a prescriptive modeling, a descriptive modeling, data mining, text analytics, forecasting, and simulation.

Typically, the OSDS 102 stores data about the plurality of objects. The data includes the individualized information of each object of the plurality of objects. The individualized information of each object includes the one or more performance parameters, the set of performance values, and the timestamps for each performance value of the set of performance values. In addition to this, the individualized information also includes historical information about the object. This historical information includes past state information of the object, one or more service actions that were undertaken for the object and so forth.

In an embodiment, the OSDS 102 processes the individualized information of the plurality of objects and identifies the object that are contextually related to the object. Typically, the analysis is performed by utilizing AI or machine learning techniques. The other objects that are contextually related to the object are those that are or were at some point of time were in similar situation as the object. For example, Jazmine is 35 years old, is a single parent and has three kids of age 6, 8 and 11 years Jazmine is of Caucasian ethnicity. She has not passed high school and recently has been diagnosed with cancer and has since lost her job. Based on this individualized information of the object, for example of Jazmine, the OSDS 102 can identify other objects that are contextually related to her. For example, the OSDS 102 identifies Raven. Raven is also of African American ethnicity. When Raven was 37 years old, she was a single parent of three kids of age 5, 9 and 12 years. She was also a high school dropout and was then diagnosed with some major illness and had lost her job. The OSDS 102 also identifies Isabela. Isabela is of Hispanic ethnicity. When Isabela was 33 years old, she had four kids of age 3, 5, 9 and 12 years. At that point she had no job and her husband was then recently deported.

In an embodiment, the analyzing of step 308 includes applying a classification and regression algorithm to the other objects that are contextually related to the object to identify a subset of performance parameters that most contribute to the current state of the object. For example, when the OSDS 102 identifies the other objects that are contextually related to the object, it also applies a classification and regression algorithm to identify a subset of performance parameters that most contribute to the current state of the object. This knowledge of the subset of performance parameters that most contribute to the current state of the object can be used in a variety of ways. In an embodiment, this knowledge can be used to select the one or more service actions that can facilitate the object in attaining the desired state. For example, if education and income are identified as the subset of performance parameters that most contribute to the current state of an object then the OSDS 102 may recommend a service action, such as granting a student loan or skill training that can address the subset of parameters, namely education and annual income.

In an embodiment, the analyzing of Step 308 includes applying a classification and regression algorithm to the plurality of objects to identify a subset of performance parameters that most contribute to a future state of the object. Typically, this can be used to select the one or more service actions that can facilitate the object in attaining a desired state. For example, for Isabela the OSDS 102 identifies that one of her performance parameters, skill (i.e. lack of vocational training) will most contribute to her future state. To address this performance parameter, a service action, for example, financial aid for vocational training can be provided to her.

In an embodiment, the OSDS 102 determines a relation between the current state of the object and the one or more parameters. In an embodiment, the relation is a causal relation. Typically, the OSDS 102 analyses the individualized information of the plurality of objects and creates a model to determine the relation between the current state of the object and the one or more parameters. Typically, AI and machine learning techniques can be utilized to create such a model. Using this model, the OSDS 102 can simulate a plurality of scenarios to test how the current state of the object changes when there is a change in at least one parameter from the one or more parameters.

At step 310, the OSDS 102 predicts a future state of the object. Typically, the future state of the object is based on the analysis the individualized information of the object and individualized information of other objects that are contextually related to the object. In another embodiment, the future state of the object is based on the analysis of the individualized information of the plurality of object. In an embodiment, the analysis includes at least one of from the group including a trend analysis, an induction analysis, a time series analysis, a correlation analysis, a regression analysis, a frequency distribution analysis, a diagnostic modeling, a predictive modeling, a prescriptive modeling, a descriptive modeling, data mining, text analytics, forecasting, and simulation.

In an embodiment, the OSDS 102 processes the individualized information of the plurality of objects. Typically, the analysis is performed by utilizing AI or machine learning techniques. In an embodiment, the OSDS 102 creates a model for predicting the future state of the object based on this analysis. For example, the OSDS 102 can predict the future state of Jazmine who is 35 years old Caucasian, a single mother of children aged 6, 8 and 11 years Jazmine has not passed high school and recently has been diagnosed with cancer and has since lost her job. In this example, the OSDS 102 may predict that in the near future Jazmine, for example, will not be able to pay her rent and likely become homeless. In an embodiment, this prediction of the future state of Jazmine is based on the analysis of the individualized information of the plurality of objects. In another embodiment, this prediction of the future state of Jazmine is based on the analysis of the individualized information of the plurality of objects that are contextually related to Jazmine

In an embodiment, this predication of the future state of the object is based on the model for predicting the future state of the object. In some embodiments, the future state of the object may be presented in a variety of scenarios. For example, the OSDS 102 may provide a list of possible occurrences and corresponding likelihood value, for example of homeless (35% likelihood), dependence on public welfare (90% likelihood) etc. In other embodiments, the OSDS 102 may simply provide the predicated future state. For example, if the state is a scale of 1-10, the OSDS 102 can predict that the object is likely to slide to a future state of 3 from the current state of 7. Typically predicting the future state of the object is based on the analysis performed at step 308.

In an embodiment, the object has one or more associated sub-objects. Each sub-object of the one or more sub-objects has an individualized information associated with the sub-object. The object and the one or more associated sub-objects constitute an object family. For example, the three children of Jazmine are the sub-objects. Also, Jazmine and her three children together constitute an object family. It should be understood to a person skilled in the art that the method 300 can be performed by the OSDS 102 for the object family in the similar manner as the method 300 is performed for the object.

In an embodiment, the OSDS 102 processes the individualized information of the object family to determine a current state of the object family. In an embodiment, the OSDS 102 analyzes the individualized information of the object family, the individualized information of other objects that are contextually related to the object, and the individualized information of other objects families that are contextually related to the object family. The other objects are from the plurality of objects. The other object families are from a plurality of object families. Thereafter, the OSDS 102 predict a future state of the object family. Typically, the future state of the object is based on the analysis of at least one of from the group including the individualized information of the object family, the individualized information of other objects that are contextually related to the object, and the individualized information of other objects families that are contextually related to the object family. The OSDS 102 then determines a desired state of the object family. Finally, the OSDS 102 recommends one or more service actions, wherein the one or more service actions facilitate the object family in attaining the desired state.

In an embodiment, the OSDS 102 predicts a future state of the one or more associated sub-objects based on at least one of from the group including the future state of the object, the current state of the object, the individualized information of the object, the individualized information of other sub-objects that are contextually related to the sub-object, the individualized information associated with the sub-object, and the individualized information of the other objects that are contextually related to the object.

In an embodiment, the OSDS 102 predicts the future state of the object family based on the future sate of the object and future state of the one or more associated sub-objects. Typically, the future state of the family can be used by the funder and/or the implementer to determined service actions that may be better suited for the object family. For example, Ronnie is 35 years old and a mother of three small children. She has recently lost her job and has no other source of income. Here, Ronnie and her three children are an object family. Since she has three young and dependent children, certain service actions will suit her better. For example, an online training course that she can take from home will be better suited for her compared to an in-person training offered across the town, as she has to take care of her children as well. Also, considering her family situation she would need additional support so that she could also take care of her children.

In an embodiment, the OSDS 102 determines that the current state of the object is below a predefined minimum. In an embodiment, the OSDS 102 determines the future state of the object only if the current state of the object is below the predefined minimum. Typically, the OSDS 102 periodically determines the current state of the plurality of objects. In case if the current status is determined to be lower than the predefined minimum then the OSDS 102 can alert the funder and/or the implementer. Thus, by using the OSDS 102 the funder and implementer can both efficiently manage their resources. Also, the OSDS 102 can be used by a plurality of funders and implementers. For example, the OSDS 102 can be used by a plurality of non-profit organizations and a plurality of government agencies. In this example, when one of the non-profit organizations initiates a service action for an object then the other non-profits also can see the service action implemented for the object and can take that into account when they decide for additional service actions. Also, when the current status of the object is determined to be lower than the predefined minimum then a the OSDS 102 can determine one or more service actions that may facilitate the object attaining the desired sate and notify one or more implementers, for example, non-profit organizations that have the resources to implement at least one of the one or more determined service actions.

At step 312 the OSDS 102 determines a desired state of the object. In an embodiment, the OSDS 102 determines that the future state of the object is below a threshold. The threshold could be a numerical value, a percentile value, a percentage value, a color value, an integer value or any other value. In an embodiment, the desired state of the object is a state where the object is, for example, financially stable and does not need any financial or other support from the funder or the implementer. Another embodiment, the desired state is a state that is better than the current state of the object. A person skilled in the art will understand that it may take numerous service actions and time before for the object attains the desired state, Typically, the object will move from current state to various intermediate states before it attains a state where it no longer needs or qualifies for any service action.

At step 314, the OSDS 102 recommends one or more service actions. The one or more service actions facilitate the object in attaining the desired state. In an embodiment, recommending the one or more service actions includes determining one or more candidate service actions. Each candidate service action, once implemented, increases the likelihood of the object attaining the desired state. From the candidate service actions, the OSDS 102 determines one or more feasible service actions based on resource availability. For example, for Jazmine the one or more candidate service actions include providing her financial aid, providing her training, providing her education and providing her home. However, OSDS 102 may determine that no funding is available for training. In this case, providing training will not be a feasible service action and the other three candidate service actions are feasible service actions. In the embodiment, after determining the feasible service actions, the OSDS 102 implements an optimization procedure to select the one or more service actions from the one or more feasible service actions. In an embodiment, the OSDS 102 may consider the plurality of objects, and based on optimization procedure and the availability of resources may select the one of more service actions from the one or more feasible service actions.

Typically, the OSDS 102 sends a notification on determining shortage of at least one resource. The notification sent to a funder and/or implementer that may be able to help in reducing the shortage of the at least one resource through, for example, additional funding and/or new program. For example, when the OSDS 102 determines that there is no or less than required funding available for Jazmine it may send a notification to one or more funders and/or implementers who may approve funding for her training. In an embodiment, when the funder or implementer approves the funding that may address the shortage of the resource, the OSDS 102 may convert a candidate service action to a feasible service action. For example, if a funder approves the funding for Jazmine's training, then the OSDS 102 will make providing training as a feasible service action. In this example, the OSDS 102 will then consider providing training to Jazmine as a feasible service action for the optimization procedure to select the one or more service actions.

In an embodiment, the OSDS 102 provides each service action of the one or more service actions in the form of a decision tree. The decision tree includes one root node, one or more sub-nodes and a plurality of leaf-nodes. The service action corresponds to the root node, one or more anticipated service actions correspond to the one or more sub-nodes and a plurality of future states of the object correspond to the plurality of leaf nodes. Thus, the OSDS 102 presents a Graphical User Interface (GUI) to a user, for example to the funder or the implementer to simulate and view how the state of the object or object family will change on application of a plurality of service actions.

In an embodiment, the OSDS 102 determine a development plan for the object, for example, the object 120. The development plan includes one or more intermediate states of the object 120 and the desired state of the object 120. In addition, the OSDS 102 monitors progress of the object to determine if the object is on track for attaining the desired state. In an embodiment, the OSDS 102 enables a user, for example the implementer 114 to determines a development plan for the object 120. Typically, the development plan includes a one or more service actions and also a plan of implementation of the one or more service actions over a period of time. The plan also determines one or more intermediate states of the object leading to the desired state. For example, a development plan for object 120 includes service actions 1 to 4 and intermediate states 1 and 2 and a desired state 3. This development plan also includes a plan schedule for implementation of the service actions 1 to 5. This plan schedule includes implementing service action 1 for 3 months and target intermediate state 1, then implementing service actions 2 and 3 simultaneously for 6 months and target state 2, followed by implementing service action 4 for 1 year and the desired state 3. In this example, the OSDS 102 periodically monitors the progress of the object 106. In case the object deviates from the development plan, for example fails to reach an intermediate state then the implementer 114 gets notified so that he/she can plan for additional corrective actions, for example, creating a new development plan or implementing a new service action or modifying the one or more service actions as appropriate. Thereafter, at step 316 the method 300 terminates.

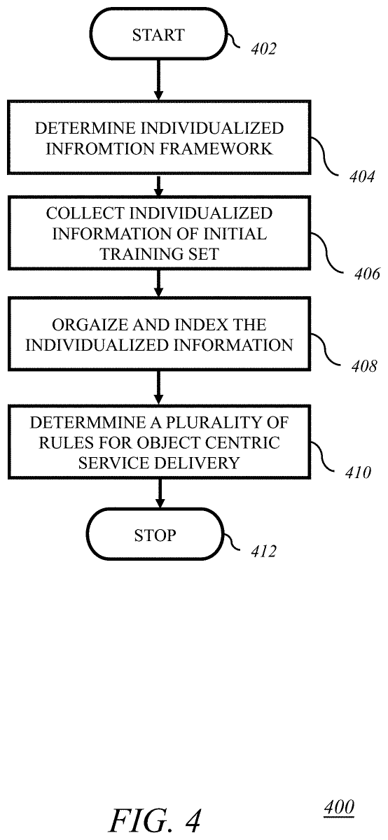

FIG. 4 is a flowchart illustrating an exemplary method 400 for setup of object-centric service delivery in accordance with various embodiments of the present invention. The exemplary method 400 is merely an illustration of the setup of the object-centric service delivery. Other methods and processes are possible, and more or fewer steps of setup may be implemented by the OSDS 102 in various embodiments. To describe the method 400, reference has been made to FIG. 1 and FIG. 2, although it should be understood that the method 400 could be implemented in any other suitable environment or network. Moreover, the invention is not limited to the order in which the steps are listed in the method 400. In an embodiment, the method 400 is performed by the OSDS 102.

At step 402 the method 400 is initiated. In an embodiment, the present invention predicts the future state of an object, for example the object 120 and recommends one or more service actions that facilitate the object 120 in attaining a desired state. Typically, the OSDS 102 receives individualized information of objects belonging to an initial training set and identifies patterns or rules from the received individualized information. The patterns or rules identify a subset of performance parameters that are key predictor of the future state of the object.

In an embodiment, the method of object-centric service delivery implemented by OSDS 102 requires an initial training set so that it can develop a set of rules and identify patterns. Typically, initial training set includes individualized information of a subset of the plurality of objects. The process of identifying patterns or rules is an iterative process and with time and with each iteration the OSDS 102 may learn new rules and identify new patterns that will improve accuracy of its prediction. In addition, performance of the OSDS 102 also improves with time as it receives individualized information of more objects. Typically, the OSDS 102 keeps track of the individualized information and state information (current state, future state, desired state etc.) of numerous objects and the effect of service actions implemented for each of these objects. This tracking enables the OSDS 102 to learn and make improvements in its prediction.

At step 404 the OSDS 102 determines an individualized information framework. The individualized information framework includes one or more performance parameters. In an embodiment, the performance parameter is at least one of from the group including an intrinsic parameter, and an extrinsic parameter. Examples of the performance parameters include, but are not limited to citizenship, immigration history, marriage, correctional information, credit history, education background, skills and training, employment history, entrepreneurial experience, annual income, health, housing, identification, personal finance, veteran benefit, size of household, and residence address. Typically, the intrinsic parameters are parameters that are specific to the object, for example ethnicity, income. Typically, the extrinsic parameters are parameters that are external to the object, for example, unemployment rate, labor participation rate, consumer price index, per capital income of the locality, unemployment insurance claims data etc.

In an embodiment, a user of the OSDS 102, for example, the funder agent 116, the implementer agent 118 or the object 120 may add a new performance parameter. In an embodiment, the OSDS 102 may determine at least one performance parameter after executing the method 300 and add the new performance parameters to the one or more performance parameters. Typically, the OSDS 102 presents the at least one performance parameter to the user, for example, to the implementer agent 118 or the funder agent 116 so that the user may select a subset of performance parameters from the at least one performance parameter to be added to the one or more performance parameters. For example, the OSDS 102 may identify that for a particular geography and/or a particular ethnic group, being in more than one foster care has a strong correlation with a future need of service action. In this example, the OSDS 102 may add a new performance parameter of “number of foster cares” to the one or more performance parameters. Alternatively, the OSDS 102 may recommend adding the new performance parameter of “number of foster cares” to at least one of, the implementer agent 118 and the funder agent 116, who may decide to add the new performance parameter to the one or more performance parameters. A person skilled in the art will understand that there are many candidate performance parameters that can be utilized by the OSDS 102. For this reason, it is important to properly analyze and control which performance parameters should be used by the OSDS 102.

At step 404, the OSDS 102 also defines a scale for each of the one or more performance parameters. For example, annual income will have a currency scale, citizenship will have a country scale, household size will have a numerical scale and so forth. Typically, the OSDS 102 defines the normalized value for the one or more parameters. Example of the normalized value is a numerical value between 1 to 10 or between −5 to +5 etc. Other examples of the normalized value include, but are not limited to, a percentage scale, a percentile scale, a logarithmic, a non-numeric scale and so forth.

At step 406, the OSDS 102 collects the individualized information of one or more objects of the initial training set. It is important to understand that the individualized information of the one or more objects may include noisy information, missing information and even in some cases invalid or false information. The collection of the individualized information of the one or more objects requires a decision on the number of the objects for which the individualized information is to be collected. On one hand if there are too few cases to collect individualized information then some domain knowledge may be missing. On the other hand, if there are too many cases then the most relevant cases may get ‘diluted.’ However, a person skilled in the art will understand that for good results enough number of objects and the corresponding individualized information is required so that statistical tests, correlation and cluster verification etc. may be performed in a meaningful manner.

In an embodiment, a series of diagnostic questions are prepared for each performance parameter so that the OSDS 102 can identify key success drivers or discriminators using AI techniques like rule induction algorithms. Typically, the data source of the individualized information is completed questionnaires base on the information provided by the one or more objects. In an embodiment, the individualized information of the one or more objects is obtained from entities that routinely collect this kind of information, for example, government entities such as counties, cities, municipalities; social security administration; department of motor vehicles (DMV); department of veteran affairs; public safety agencies; correctional agencies; court records and so forth. The individualized information of the one or more object can also be collected from private entities such as, financial institutions, hospital, charitable institutions, NGOs, funders, implementers and other such entities that may have the individualized information of the object. In an embodiment, the individualized information of the one or more objects is obtained from social media activity of the one or more objects. Typically, the OSDS 102 utilizes surveillance data collection methods to obtain the individualized information of the one or more objects. In an embodiment, the individualized information of an object is based on the object's interaction with the OSDS 102. The object's interaction with the OSDS 102 includes purchasing goods/services available on the OSDS 102, registering for one or more service actions, search for service actions etc. Typically, the individualized information of the plurality of objects is stored in the database 210.

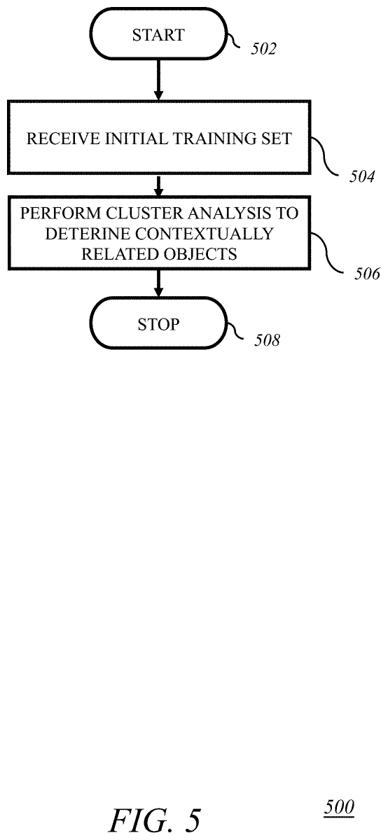

At Step 408, the OSDS 102 organizes and indexes the individualized information of the one or more objects. In an embodiment, for each object of the one or more objects, the OSDS 102 identifies other objects that are contextually related to the object. This process of identification of similarities and identification of closest set of objects which support decision making process of the OSDS 102 and organizing and indexing a knowledge base is one of the key aspects of the object centric service delivery system. The process of determining other objects that are contextually related to the object is explained in conjunction with FIG. 5.

In an embodiment, the one or more objects and the corresponding individualized information is stored and indexed in the database 210. Typically, each object of the one or more objects is given a unique identifier. The OSDS 102 creates a plurality of views for each object based on at least one of from the group including, the individualized information of the object, the one or more performance parameters of the object. For example, a view can be created to identify all objects that have an annual income less than $35,000 and are second generation college graduates.

At step 410, the OSDS 102 determines a plurality of rules for the object centric service delivery. In an embodiment, the OSDS 102 uses at least one of from the group including, a trend analysis, an induction analysis, a time series analysis, a correlation analysis, a regression analysis, a frequency distribution analysis, a diagnostic modeling, a predictive modeling, a prescriptive modeling, a descriptive modeling, data mining, text analytics, forecasting, and simulation for deriving the rules from the one or more objects. Typically, the rules are derived using an induction mechanism.

In an embodiment, the OSDS 102 performs induction on the one or more of objects to determine the plurality of rules. In another embodiment, the OSDS 102 performs induction on the plurality of objects to determine the plurality of rules. Typically, the plurality of rules may be in the form of a decision tree. In an embodiment, the OSDS 102 applies one or more rules form the plurality of rules, to determine if an object or an object family needs at least one service action. In an embodiment, the OSDS 102 also creates a model to predict a future state of the object or the object family, determine the desired state of the object or the object family and recommend the one or more service actions that facilitate the object or the object family in attaining a desired state. Thereafter, at step 412 the method 400 terminates.

FIG. 500 is a flowchart illustrating an exemplary method 500 for determining contextually related objects in accordance with various embodiments of the present invention. The exemplary method 500 is merely an illustration of the setup of the object-centric service delivery. Other methods and processes are possible, and more or fewer steps of setup may be implemented by the OSDS 102 in various embodiments. To describe the method 500, reference has been made to FIG. 1 and FIG. 2, although it should be understood that the method 500 could be implemented in any other suitable environment or network. Moreover, the invention is not limited to the order in which the steps are listed in the method 500. In an embodiment, the method 500 is performed by the OSDS 102.

At step 502, the method 500 is initiated. At step 504, the OSDS 102 receives the initial training set which includes individualized information of a subset of the plurality of objects. In another embodiment, the OSDS 102 receives the individualized information of the plurality of objects. The individualized information of each object includes one or more performance parameters. Each performance parameter covers a performance area of the object and has a set of performance values. Each performance value of the set of performance values is associated with a time-stamp. The individualized information of each object also includes details of one or more service actions (if any) that were implemented for the object.

At step 506, the OSDS 102 performs a cluster analysis on the subset of the plurality of object. The cluster analysis results in a plurality of clusters. Cluster analysis is an exploratory data analysis which aims at sorting different objects into groups or clusters in a way that the degree of association between two objects in maximal if they belong to the same group and minimal otherwise. Typically, cluster analysis can be used to discover structure in data without providing an explanation or interpretation. In an embodiment, the OSDS 102 performs cluster analysis to determine one or more objects that are contextually related to each other. Typically, objects that that belong to a same cluster are contextually related to each other.

In an embodiment, the cluster analysis is performed by utilizing AI or machine learning techniques. The other objects that are contextually related to the object are those that are or were at some point of time were in similar situation as the object. For example, Jazmine is 35 years old, is a single parent and has three kids of age 6, 8 and 11 years. Jazmine is of Caucasian ethnicity. She has not passed high school and recently has been diagnosed with cancer and has since lost her job. Based on this individualized information of the object, for example of Jazmine, the OSDS 102 can identify other objects that are contextually related to her. For example, the OSDS 102 identifies Raven. Raven is also of African American ethnicity. When Raven was 37 years old, she was a single parent of three kids of age 5, 9 and 12 years. She was also a high school dropout and was then diagnosed with a major illness and had lost her job. The OSDS 102 also identifies Isabela. Isabela is of Hispanic ethnicity. When Isabela was 33 years old, she had four kids of age 3, 5, 9 and 12 years. At that point she had no job and her husband had also left her.

In an embodiment, the OSDS 102 uses K-Means clustering. K-Means clustering, requires selecting a number of clusters, each cluster having a randomly selected object as center for the cluster. Other objects are then classified by computing the distance between an object and the object selected as the center of the cluster. In an embodiment, the distance is calculated based on the weighted sum of the difference between the performance values of the object and the object selected as the center of the cluster. Based on the classified objects, the OSDS 102 then recomputes the center of the group by taking mean of all the objects in the group. This process is repeated until the center of the group does not change much between iterations. In another embedment, the OSDS 102 uses at least one of Means-shift clustering, Density-Bases Spatial Clustering of Applications with Noise (DBSCAN) Expectation—Maximization (EM) Clustering using Gaussian Mixture Models (GMM), and Agglomerative Hierarchical Clustering. A person skilled in the art will understand each of these clustering model has its own advantages, disadvantages and suitability for a particular situation. Therefore, depending on the circumstance, the OSDS 102 may use one or a combination of these clustering models to identify the objects that are contextually related. In an embodiment, the clusters can be evaluated and/or modified by the OSDS 102 on a periodic basis. Thereafter, at step 508 the method 500 terminates.

FIG. 600 is a flowchart illustrating an exemplary method 600 to identify objects that need at least one service action, in according to various embodiments of the present invention. The exemplary method 600 is merely an illustration of the setup of the object-centric service delivery. Other methods and processes are possible, and more or fewer steps of setup may be implemented by the OSDS 102 in various embodiments. To describe the method 600, reference has been made to FIG. 1 and FIG. 2, although it should be understood that the method 600 could be implemented in any other suitable environment or network. Moreover, the invention is not limited to the order in which the steps are listed in the method 600. In an embodiment, the method 600 is performed by the OSDS 102.

At step 602 the method 600 initiates. At step 604, the OSDS 102 receives an initial training set that includes individualized information of a subset of the plurality of objects. This first set includes a combination of objects that are known to need at least one service action and objects that are known to be not in need of any service actions. In an embodiment, the initial training set includes objects that are contextually related to each other i.e. belong to the same cluster. In this embodiment, the method 600 is executed for each cluster. A person skilled in the art will understand that a statistically relevant number of objects is required to get good results from method 600.

At step 606, the OSDS 102 analyzes the training set. Typically, the analysis includes performing various calculation such as averages, current state, normalized values and so forth for each object in the initial training set.

At step 608, the OSDS 102 creates a prediction model to identify if an object needs at least one service action. In an embodiment, the prediction model is a Computer Based Reasoning (CBR) model. In an embodiment, the prediction model includes at least one of linear regression, logistic regression, linear discriminant algorithm, classification and regression tree algorithm (CART), Naïve Bayes, K-Nearest Neighbors, Linear Vector Quantization (LVQ) algorithm, Support Vector Machines, and Bragging and Random Forest (BRF) algorithm.

A prediction model, for example a prediction model based on CBR has an ability to reason in domain that are not completely understood and to evaluate solutions when no or poor algorithmic solutions are available. In the present area of object centric service delivery, CBR supports human judgment by identifying clusters or patterns where predictive rules and procedures cannot be easily determined.

CBR is considered to come closest to how human learning and reasoning operates, given that people learn and reason mostly from past relevant cases. That is, like human reasoning, CBR includes the creation of categories and the application of rules (e.g., precise or heuristic rules). CBR also simulates a human's reliance on past experience, by defining certain events and their outcomes as cases that the CBR algorithm may search as a “past experience.” These precedent cases may then be reapplied to a current case.

More specifically, CBR allows the storage of cases relating to specific problems that have been solved already. Once the past cases have been stored in a case library, it is possible to compare and match a current unsolved case with a past one for which a solution was found. In addition, as new solved cases are added to the case library, a fuller understanding of problem solving emerges. Typically, the case library is stored and maintained in the database 210. The case library is typically implemented as a data structure centered around objects with the individualized information of the objects associated with the object, one or service actions that were successfully implemented for the objects and/or one or more service actions that were not successful for the object (if any).

In an exemplary embodiment, the OSDS 102 uses CBR technique, for e.g. a Correlation and Regression Tree (CART) algorithm to determine if an object needs at least one service action. In this embodiment, first the OSDS 102 calculates quartile value for each performance parameters of each object in the training set. Thereafter the OSDS 102 will calculate the first quartile representing the top 25% of the normalized values, the second quartile representing the next 25% of the normalized values, the third quartile representing the next 25% of the normalized values and the fourth quartile representing the bottom 25% of the normalized values. Once quartile value calculation is competed each object in the initial training set has a quartile value (1 to 4) for each parameter. Typically, the OSDS 102 performs the quartile value update at periodic intervals.

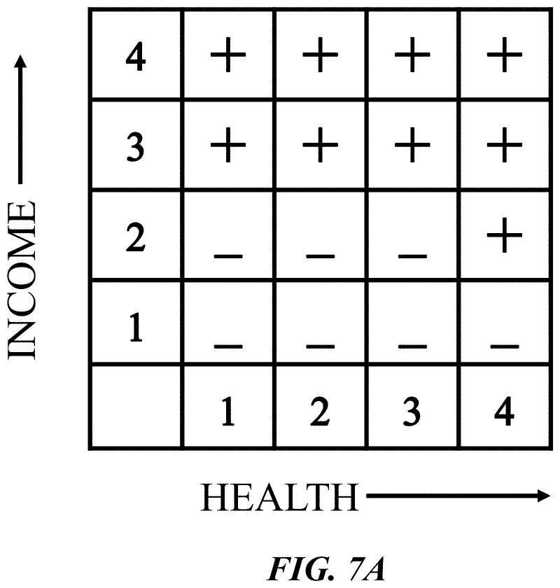

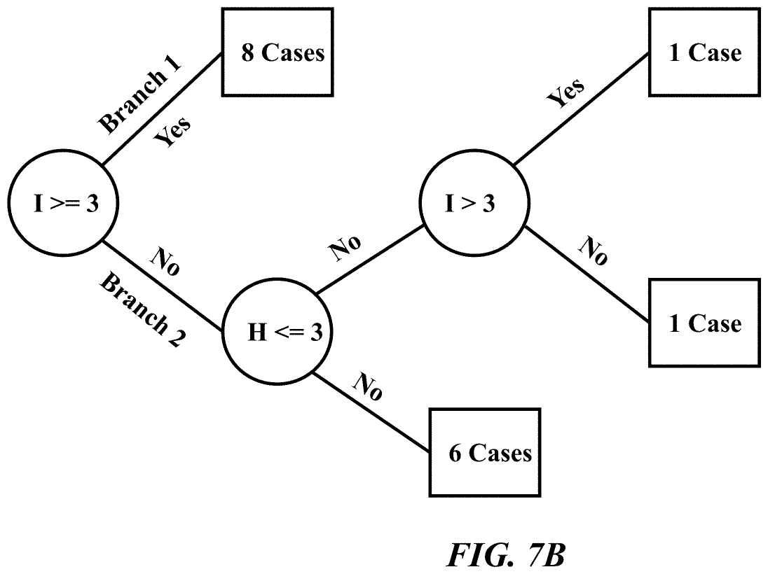

Typically, the prediction model, for e.g. the CART algorithm utilizes induction techniques. In an embodiment, the induction technique looks at all collected data and determines which performance parameter and associated quartile value drive towards a specific state of the object, for e.g. need of service action, by defining patterns or clusters. This induction technique is further explained in conjunction with FIG. 7A and 7B. In an embodiment, the current state of the object is based on a weighted average of one or more performance values. In this embodiment, the OSDS 102 determines a relation between the current state of the object and the one or more parameters of the object. In an embodiment, the OSDS 102 determines that the current state of an object is below a predefined minimum. In this embodiment, the OSDS 102 determines that the object needs a service action. After creating the prediction model to identify if an object needs at least one service action, the method terminates at step 610. Typically, the OSDS 102 repeats the method 600 at periodic intervals to ensure and improve its accuracy.

FIG. 7A and 7B illustrate the prediction methodology employed by the OSDS 102 in accordance with an embodiment of the present invention. FIG. 7A represents 16 cases of the effect of two performance parameters, namely income and health on service action need. Income and health each have a quartile value on a scale of 1 to 4 with 1 representing the lowest quartile value and 4 representing the highest quartile value. Typically, the technique illustrated in FIG. 7A and 7B is implemented for each cluster.

In FIG. 7A, the plus “+” sign means that a particular percent, say at less than 10% of the objects need at least one service action under the given income and health quartile levels and the minus “−” sign means that more than a particular percent, say 10% of the objects need service action under the given income and health quartile level. The CBR algorithm is applied on the data set in the table 7A to determine the most significant factor (income or health) on the need of a service action.

The CBR algorithm iterates through multiple solutions based on the data set to identify a first most significant performance parameter. In an embodiment, the CBR algorithm is applied on the data set in table 7A. The CBR algorithm identifies income having a level of 3 or more as the most significant performance parameter affecting the need of service action. For cases having an income level of 3 or more the object 120 will not need a service action no matter what is the value of health. As the CBR algorithm loops through the data set, the next most significant performance parameter is health having a value of 3 or less. For all cases having a health value of 3 or less, and an income value of 3 or less an object needs a service action. The third most significant performance parameter is income greater than 1 and so forth. A person skilled in the art will understand that the CBR can be applied through a plurality of performance parameters to determine which performance parameter and associated quartile value drive towards a specific state of the object, for e.g. need of service action. In an embodiment, the CBR is applied to determine the weightage of each performance parameter. The weightage is used to determine the relation between the current state of the object and the one or more performance parameters. In an embodiment, by utilizing this prediction model the OSDS 102 can determine if an object, for e.g. the object 120 needs at least one service action.

The results of the CBR algorithm on the data set of FIG. 7A is graphically depicted on FIG. 7B. In an embodiment, CBR algorithm is Classification and Regression Tree (CART) algorithm. The CART algorithm builds classification trees as shown in 7B. In some cases, the CART algorithm may give the user the flexibility to prune nodes. Typically, with a CART algorithm, it is necessary to start with a root node that has all cases in training set. Typically, the algorithm will “loops” until there are too few remining cases. To do that, the CART algorithm will scan through all the possible splits of nodes until an optimal split is reached. Once it has determined the optimal split, it creates nested sequences of sub-trees where it has split the data. CART also uses error techniques to refine the optimal final tree. In an embodiment, it gives the option of splitting cases “breadth” or “depth” first and it is also possible to influence the final tree by using qualitative weightings.

In an embodiment, the individualized information of the object includes historical information about the object as well. This historical information includes past state information of the object, and past set of performance values of the object, past service actions and so forth. The OSDS 102 uses the historical information of objects prior to a time when the objects needed at least one service action and creates a prediction model to determine if an object will need a service action in the future.

In an embodiment, the method 600 and the methodology described in FIG. 7A and FIG. 7B can be applied to create a prediction model for determining if an object will need at least one service action in future. In an embodiment, the prediction model provides a plurality of weightage values for the one of more performance parameters such that on applying the weightage values to one or more performance parameters the OSDS 102 determine if an object will need at least one service action in the near future (e.g. next few months). Typically, the OSDS provides a probability value, for example, a probability of 0.7 that the object 120 will need a service action in the next 6 months. In an embodiment, the OSDS 102 determines that the future state of the object is below a threshold. In this embodiment, the OSDS 102 determines that the object will need at least one service action in the future.

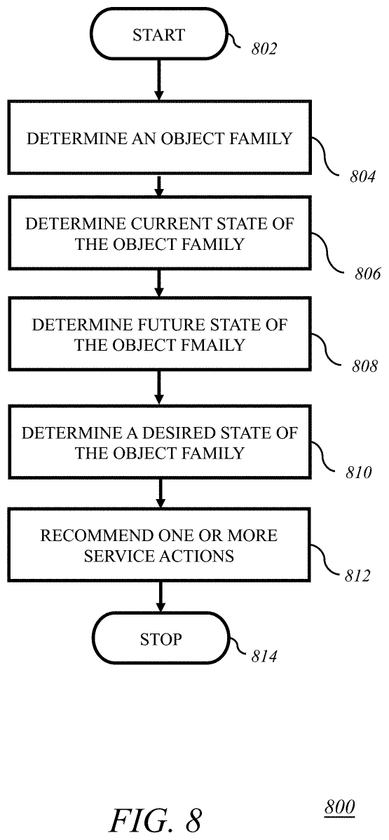

FIG. 8 is a flowchart illustrating an exemplary method 800 for object centric service delivery in accordance with another embodiment of the present invention. The exemplary method 800 is merely an illustration of the setup of the object-centric service delivery. Other methods and processes are possible, and more or fewer steps of setup may be implemented by the OSDS 102 in various embodiments. To describe the method 800, reference has been made to FIG. 1 and FIG. 2, although it should be understood that the method 800 could be implemented in any other suitable environment or network. Moreover, the invention is not limited to the order in which the steps are listed in the method 800. In an embodiment, the method 800 is performed by the OSDS 102.

At Step 810 the method 800 is initiated. At Step 802, the OSDS 102 determines an object family of an object, for example, an object family of the object 120. Typically, the object has one or more associated sub-objects wherein the object and the associated sub-objects constitute the object family.

At step 804, the OSDS 102 determines the current state of the object family. Typically, the OSDS 102 determines the current state of the object family by processing the individualized information of the object family.

At step 806, the OSDS 102 identifies context information for the object family. In an embodiment, the OSDS 102 analyzes at least one of the individualized information of the object family, individualized information of other objects that are contextually related to the object, and individualized information of other object families that are contextually related to the object family. In an embodiment, identifying context information includes at least one of from the group including a trend analysis, an induction analysis, a time series analysis, a correlation analysis, a regression analysis, a frequency distribution analysis, a diagnostic modeling, a predictive modeling, a prescriptive modeling, a descriptive modeling, data mining, text analytics, forecasting, and simulation.

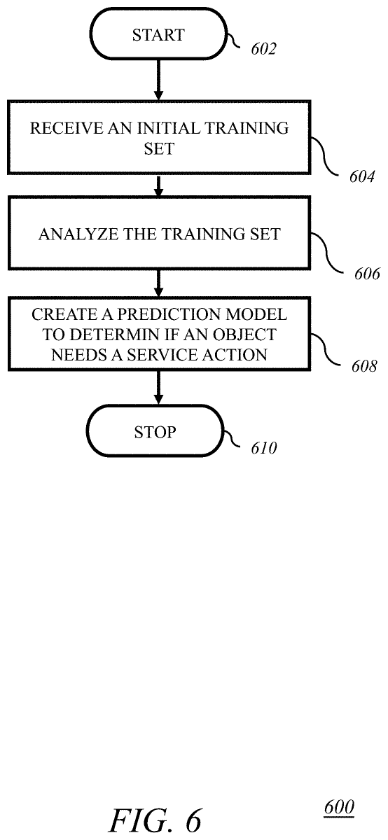

In an embodiment, the OSDS 102 employs a case-based reasoning (CBR) for the analysis performed in step 806 by using techniques and methods explained in conjunction with FIG. 5, FIG. 6, FIG. 7A and FIG. 7B. Typically, the analysis in Step 806 is performed till a key performance parameter is identified. Thereafter, the analysis continues till all the key performance parameters are identified.

At step 808, the OSDS 102, determines a future state of the object family. Typically, the OSDS 102 deploys AI techniques, for example a CBR algorithm to develop a prediction model to determine the future state of the object family. Typically, the OSDS 102 predicts a future state of the one or more associated sub-objects based on at least one of from the group including the future state of the object, the current state of the object, the individualized information of the object, the individualized information of other sub-objects that are contextually related to the sub-object of the object, the individualized information associated with the sub-object of the object, and the individualized information of the other objects that are contextually related to the object. Thereafter, the OSDS 102 predicts the future state of the object family based on the future sate of the object and future state of the one or more associated sub-objects of the object.

At step 810, the OSDS 102 determines a desired state of the object family. Typically, the desired state of the object 120 is determined based on the policies of the implementer and/or the funder. Typically, the desired state of the object 120 is a state wherein the object family is self-sustaining or self-sufficient and no longer needs any service action.

At step 812, the OSDS 102 recommends one or more service actions. The one or more service actions facilitate the object family in attaining a desired state. Typically, the OSDS 102 recommends one or more service actions based on the key performance parameters identified in step 814. In an embodiment, the OSDS 102 determines a plurality of service actions that have successfully worked for at least one of, other objects that are contextually related to the object, other objects families that are contextually related to the object family. Typically, from the plurality of service actions the OSDS 102 selects at least one service action that facilitate the object family in attaining the desired state. In an embodiment, this selection of the one or more service actions is based on methods and techniques explained in FIG. 3, FIG. 5, FIG. 6, FIG. 7A and FIG. 7B. Thereafter, the method 800 terminates at step 814.

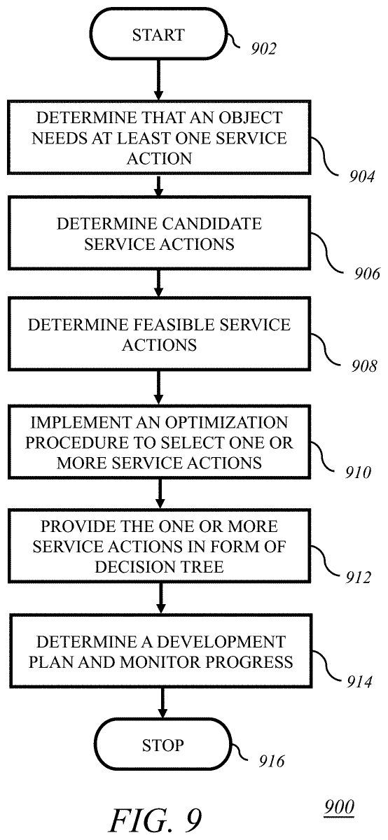

FIG. 9 is a flow diagram illustrating an exemplary method 900 for recommending one or more service actions in accordance with various embodiments of the present invention. The exemplary method 900 is merely an illustration of the setup of the object-centric service delivery. Other methods and processes are possible, and more or fewer steps of setup may be implemented by the OSDS 102 in various embodiments. To describe the method 900, reference has been made to FIG. 1 and FIG. 2, although it should be understood that the method 900 could be implemented in any other suitable environment or network. Moreover, the invention is not limited to the order in which the steps are listed in the method 900. In an embodiment, the method 900 is performed by the OSDS 102.

At step 902 the method initiates. At step 904, the OSDS 102 determines that an object, for example the object 120 needs at least one service action. In an embodiment, the OSDS 102 determines that the object needs the at least one service action when the current state of the object is below a predefined minimum. In another embodiment, the OSDS 102 determines that the object needs a service action when the future state of the object is determined to be below a threshold.

At step 906, the OSDS 102 determines one or more candidate service actions. In an embodiment, a candidate service action from the one or more candidate service actions increase the likelihood of the object in attaining the desired state. In an embodiment, the OSDS 102 employs prescriptive analytics to determine the one or more candidate service actions.

Typically, prescriptive analytics provides the OSDS 102 with best options of dealing with a given situation based on the concept of optimizing the process of choosing between the available options. Prescriptive analytics formulate optimization of outcomes by combining historical data, rules, mathematical models, variables, constraints and machine learning. In an embodiment, prescriptive analytics uses Monte Carlo simulations to recommend next steps, display if/then scenarios and thereby provide a better understanding of the range of possible outcomes.

In an embodiment, the OSDS 102 has the individualized information of other objects that are contextually related to the object, for example the object 120. The OSDS 102 also has prior state information of the other objects and a record of the service actions that were implemented for the other objects. Moreover, the OSDS 102 also has one or more key performance parameters of the object. Based on all this information, the prediction model identifies the one or more candidate service actions. Typically, each candidate service action is based on service actions that have helped in improving the state of at least one object from the other objects that are contextually related to the object.

At step 908, the OSDS 102 determines one or more feasible service actions. Typically, this determining is based on resource availability. For example, the OSDS 102 determines providing training, food and employment as one or more candidates service actions. In this case if the implementer, for example an NGO does not have resources/funds available for providing training then providing training is not a feasible service action and providing food and employment are feasible service actions.

At step 910, the OSDS 102 implements an optimization procedure to select one or more service actions from the one or more feasible service actions. In an embodiment, when there are more feasible service actions then needed then the OSDS 102 may reject one or more feasible service actions. This helps in better utilization of resources of the implementer and the funder. In an embodiment, the optimization procedure also helps the OSDS 102 in determining an implementation sequence of the one or more service actions. Typically, the implementation sequence results in better results.

At step 912 the OSDS 102 provides the one or more service actions in form of a decision tree. Each decision tree includes one root node, one or more sub-nodes and a plurality of leaf-nodes. A service action corresponds to the root node, one or more anticipated service actions correspond to the one or more sub-nodes and a plurality of future states of the object correspond to the plurality of leaf nodes. Typically, the decision tree enables the user, for example the implementer agent 118 or the object 120 to visually see the effect of the one or more feasible service action to better understand the problem and the solution.

At step 914, the OSDS 102 determines a development plan for the object. The development plan comprises one or more intermediate states of object and the desired state of the object. In an embodiment, the OSDS 102 monitors the progress of the object to determine if the object is on track of attaining the desired state. Thereafter, at step 916 the method terminates.

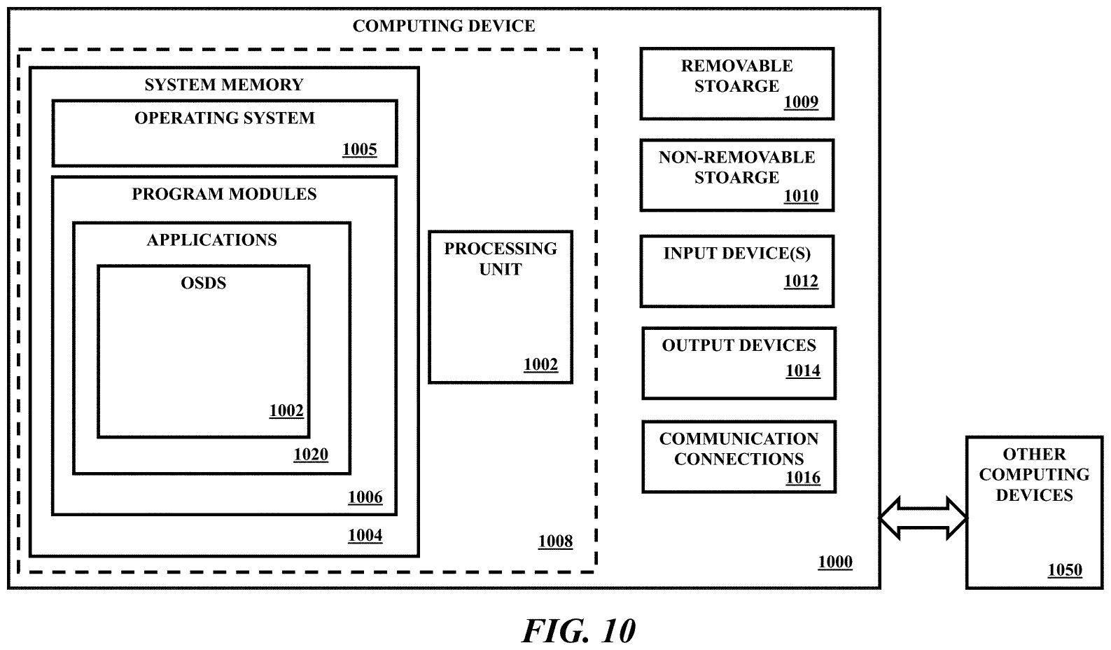

FIGS. 10 and the associated descriptions provide a discussion of a variety of operating environments in which aspects of the disclosure may be practiced. However, the devices and systems illustrated and discussed with respect to FIGS. 10 is for purposes of example and illustration and are not limiting of a vast number of computing device configurations that may be utilized for practicing aspects of the disclosure, described herein.

FIG. 10 is a block diagram illustrating physical components (e.g., hardware) of a computing device 1000 with which aspects of the disclosure may be practiced. For example, the OSDS 102 could be implemented by the computing device 1000. In some aspects, the computing device 1000 is a personal computer, a desktop computer, a enterprise server, a database server, a storage server, a supercomputer, an artificial intelligent server etc. The computing device components described below may include computer executable instructions for OSDS 102 that can be executed to employ method 300 for object-centric service delivery as disclosed herein. In a basic configuration, the computing device 1000 may include at least one processing unit 1002 and a system memory 1004. Depending on the configuration and type of computing device, the system memory 1004 may comprise, but is not limited to, volatile storage (e.g., random access memory), non-volatile storage (e.g., read-only memory), flash memory, or any combined of such memories. In the embodiment, the system memory 1004 is remote from the device 1000. In an embodiment, the system memory 1004 is a cloud-based storage connected to the communication device 1000. The system memory 1004 may include operating system 1005 and one or more program modules 1006 suitable for running applications 1020. The operating system 1005, for example, may be suitable for controlling the operation of the computing device 1000. Furthermore, aspects of the disclosure may be practiced in conjunction with a graphics library, other operating systems, or any other application program and is not limited to any particular application or system. This basic configuration is illustrated in FIG. 10 by those components within a dashed line 1008. The computing device 1000 may have additional features or functionality. For example, the computing device 1000 may also include additional data storage devices (removable and/or non-removable) such as, for example, magnetic disks, optical disks, or tape. The additional data storage devices can be remotely located, for example, over a cloud. Such additional storage is illustrated in FIG. 10 by a removable storage device 1009 and a non-removable storage device 1010. In an embodiment, the individualized information of the plurality of objects, data about funders, data about implementers, the AI models and algorithms could be stored on any of the illustrated storage devices.

As stated above, a number of program modules and data files may be stored in the system memory 1004. While executing on the processing unit 1002, the program modules 1006 (e.g., the OSDS 102) may perform processes including, but not limited to, performing method 300, 400, 500, 600, 700, 800 and 900 as described herein. For example, the processing unit 1002 may implement the OSDS102. In an embodiment, the OSDS 102, may include a user interface application, an AI engine, a storage application, a dashboard application, a GUI application, an email application, a social networking application, a collaboration application, a messaging application, a word processing application, a spreadsheet application, a database application, a presentation application, a contacts application, an account management application, a project management application, a finance management application, a gaining application, an e-commerce application, an e-business application, a transactional application, an exchange application, a device control application, a web interface application, a calendaring application, an Enterprise Resource Planning(ERP) application, a Customer Relationship Management (CRM) application, a Supply Chain Management (SCM) application, etc.

Furthermore, aspects of the disclosure may be practiced in an electrical circuit comprising discrete electronic elements, packaged or integrated electronic chips containing logic gates, a circuit utilizing a microprocessor, or on a single chip containing electronic elements or microprocessors. For example, aspects of the disclosure may be practiced via a system-on-a-chip (SOC) where each or many of the components illustrated in FIG. 10 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, may be operated via application-specific logic integrated with other components of the computing device 1000 on the single integrated circuit (chip).

Aspects of the disclosure may also be practiced using other technologies capable of performing logical operations such as, for example, AND, OR, and NOT, including but not limited to mechanical, optical, fluidic, and quantum technologies. In addition, certain aspects of the disclosure may be practiced within a general-purpose computer or in any other circuits or systems.

The computing device 1000 may also have one or more input device(s) 1012 such as a keyboard, a mouse, a pen, a microphone or other sound or spoken language input device, a touch or swipe input device, etc. The output device(s) 1014 such as a display, speakers, a printer, etc. may also be included. The aforementioned devices are examples and others may be used. The computing device 1000 may include one or more communication connections 1016 allowing communications with other computing devices 1050. Examples of suitable communication connections 1016 include, but are not limited to, RF transmitter, receiver, and/or transceiver circuitry, universal serial bus (USB), parallel, and/or serial ports.

The term computer readable media or storage media as used herein may include computer storage media. Computer storage media may include volatile and nonvolatile, removable and non-removable media implemented in any method or technology for storage of information, such as computer readable instructions, data structures, or program modules. The system memory 1004, the removable storage device 1009, and the non-removable storage device 1010 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 1000. Any such computer storage media may be part of the computing device 1000. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

In the foregoing specification, the invention and its benefits and advantages have been described with reference to specific embodiments. However, one with ordinary skill in the art would appreciate that various modifications and changes can be made without departing from the scope of the present invention, as set forth in the claims. Accordingly, the specification and the figures are to be regarded in an illustrative rather than a restrictive sense, and all such modifications are intended to be included within the scope of the present invention. The benefits, advantages, solutions to problems, and any element(s) that may cause any benefit, advantage or solution to occur or become more pronounced are not to be construed as critical, required or essential features or elements of any or all the claims. The invention is defined solely by the appended claims, including any amendments made during the pendency of this application, and all equivalents of those claims, as issued.

What is claimed is:

1. An object centric service delivery system (OSDS), the OSDS comprising:
at least one processor; and
a memory for storing and encoding computer executable instructions that, when executed by the at least one processor is operative to:
receive an individualized information of an object, wherein the object is from a plurality of objects, the individualized information comprising one or more performance parameters, wherein a performance parameter covers a performance area of the object, and wherein the performance parameter has a set of performance values;
process the individualized information of the object to determine a current state of the object;
analyze the individualized information of the object and individualized information of other objects that are contextually related to the object, wherein the other objects are from the plurality of objects;
predict a future state of the object;
determine a desired state of the object; and
recommend one or more service actions, wherein the one or more service actions facilitate the object in attaining the desired state.

2. The OSDS according to claim 1, wherein each performance value of the set of performance values is associated with a time-stamp.

3. The OSDS according to claim 1, wherein the current state of the object is based on a weighted average of one or more performance values.

4. The OSDS according to claim 1, wherein the other objects that are contextually related to the object are determined by applying on the plurality of objects, least one of from the group comprising a trend analysis, an induction analysis, a time series analysis, a correlation analysis, a regression analysis, a frequency distribution analysis, a diagnostic modeling, a predictive modeling, a descriptive modeling, data mining, text analytics, forecasting, and simulation.

5. The OSDS according to claim 1, wherein analyze comprises at least one of from the group comprising a trend analysis, an induction analysis, a time series analysis, a correlation analysis, a regression analysis, a frequency distribution analysis, a diagnostic modeling, a predictive modeling, a prescriptive modeling, a descriptive modeling, data mining, text analytics, forecasting, and simulation.

6. The OSDS according to claim 1, wherein the analyze comprises applying a classification and regression algorithm to the plurality of objects to identify a subset of performance parameters that most contribute to the current state of the object.

7. The OSDS according to claim 1, wherein the at least one processor is operative to determine a relation between the current state of the object and the one or more parameters.

8. The OSDS according to claim 1, wherein the at least one processor is operative to determine that the current state of the object is below a predefined minimum.

9. The OSDS according to claim 1 wherein the at least one processor is operative to determine that the future state of the object is below a threshold.

10. The OSDS according to claim 1, wherein the object has one or more associated sub-objects, wherein a sub-object has an individualized information associated with the sub-object, and wherein the object and the one or more associated sub-objects constitute an object family.

11. The OSDS according to claim 10, wherein the at least one processor is operative to:
process the individualized information of the object family to determine a current state of the object family;
analyze at least one of the individualized information of the object family, individualized information of other objects that are contextually related to the object, and individualized information of other objects families that are contextually related to the object family, wherein the other objects are from the plurality of objects, and wherein the other object families are from a plurality of object families;
predict a future state of the object family;
determine a desired state of the object family; and
recommend one or more service actions, wherein the one or more service actions facilitate the object family in attaining the desired state.

12. The OSDS according to claim 11, wherein the at least one processor is operative to:
predict a future state of the one or more associated sub-objects based on at least one of from the group comprising the future state of the object, the current state of the object, the individualized information of the object, the individualized information of other sub-objects that are contextually related to the sub-object, the individualized information associated with the sub-object, and the individualized information of the other objects that are contextually related to the object, and
predict the future state of the object family based on the future sate of the object and future state of the one or more associated sub-objects.

13. The OSDS according to claim 1, wherein recommend the one or more service actions comprises:
determine one or more candidate service actions, wherein a candidate service action from the one or more candidate service actions increases the likelihood of the object in attaining the desired state;
determine one or more feasible service actions based on resource availability; and
implement an optimization procedure to select the one of more service actions from the one or more feasible service actions.

14. The OSDS according to claim 1, wherein the at least one processor is operative to provide each service action of the one or more service actions in form of a decision tree, wherein the decision tree includes one root node, one or more sub-nodes and a plurality of leaf-nodes, wherein the service action corresponds to the root node, one or more anticipated service actions correspond to the one or more sub-nodes and a plurality of future states of the object correspond to the plurality of leaf nodes.

15. The OSDS according to claim 1, wherein the at least one processor is operative to:
determine a development plan for the object, wherein the development plan comprises one or more intermediate states of the object and the desired state of the object; and
monitor progress of the object to determine if the object is on track for attaining the desired state.

16. A method for object centric service delivery, the method comprising:
receiving an individualized information of an object, wherein the object is from a plurality of objects, the individualized information comprising one or more performance parameters, wherein a performance parameter covers a performance area of the object, and wherein the performance parameter has a set of performance values;
processing the individualized information of the object to determine a current state of the object;
analyzing the individualized information of the object and individualized information of other objects that are contextually related to the object, wherein the other objects are from the plurality of objects;
predicting a future state of the object;
determining a desired state of the object; and
recommending one or more service actions, wherein the one or more service actions facilitate the object in attaining the desired state.

17. The method according to claim 16, wherein analyzing comprises at least one of from the group comprising a trend analysis, an induction analysis, a time series analysis, a correlation analysis, a regression analysis, a frequency distribution analysis, a diagnostic modeling, a predictive modeling, a prescriptive modeling, a descriptive modeling, data mining, text analytics, forecasting, and simulation.

18. The method according to claim 16 wherein, recommending the one or more service actions comprises:
determining one or more candidate service actions, wherein a candidate service action from the one or more candidate service actions increases the likelihood of the object attaining the desired state;
determining one or more feasible service actions based on resource availability;
implementing an optimization procedure to select the one of more service actions from the one or more feasible service actions; and
sending a notification on determining shortage of at least one resource.

19. The method according to claim 1, wherein recommending the one or more service actions comprises:
determining one or more candidate service actions, wherein a candidate service action from the one or more candidate service actions increases the likelihood of the object attaining the desired state;
determining one or more feasible service actions based on resource availability; and
implementing an optimization procedure to select the one of more service actions from the one or more feasible service actions.

20. A computer program product, comprising:
a computer readable storage medium having program instructions embodied therewith, wherein the computer readable storage medium is not a transitory signal per se, the program instructions readable by at least one processing circuit to cause the at least one processing circuit to perform a method of object centric service delivery, the method comprising:
receiving an individualized information of an object, wherein the object is from a plurality of objects, the individualized information comprising one or more performance parameters, wherein a performance parameter covers a performance area of the object, and wherein the performance parameter has a set of performance values;
processing the individualized information of the object to determine a current state of the object;
analyzing the individualized information of the object and individualized information of other objects that are contextually related to the object, wherein the other objects are from the plurality of objects;
predicting a future state of the object;
determining a desired state of the object; and
recommending one or more service actions, wherein the one or more service actions facilitate the object in attaining the desired state.
